(19) United States
(12) Patent Application Publication
(10) Pub. No.: US 2002/0039492 A1
(43) Pub. Date: Apr. 4, 2002

(54) Dual-use camera and digital image-capturing device therefor

(76) Inventors: Sheng-Hui Chen, Hsinchu (TW); Hau-Yu Chang, Taipei (TW); Yang Ni, Hsinchu (TW); Chun-Hsing Hsieh, Hsinchu (TW)

Correspondence Address: MARGER JOHNSON & McCOLLOM, P.C., 1030 SW Morrison Street, Portland, OR, 97205, US

(21) Appl. No.: 09/865,980

(22) Filed: May 25, 2001

(30) Foreign Application Priority Data
Oct. 2, 2000 (TW) 089217074

(51) Int. Cl. G03B 17/48; H04N 7/18

(52) U.S. Cl. 396/429; 348/64

(57) ABSTRACT

A digital image-capturing device is mounted removably in a film-loading chamber of a camera body, and includes a lens unit disposed in front of an image-sensing device. The image-sensing device and the lens unit are aligned with a lens member on the camera body along an optical axis when the image-capturing device is disposed in the film-loading chamber. Activation of a shutter mechanism enables the lens unit to refract light rays from the lens member so as to adjust focusing and size of an image of a target object that is formed on a sensing plane of the image-sensing device. A memory device stores digital image data generated by the image-sensing device. A control device controls exposure time of the image-sensing device, and further controls storage of data in the memory device.

### BACKGROUND OF THE INVENTION

1. Field of the Invention

The invention relates to a camera, more particularly to a dual-use camera and a digital image-capturing device therefor.

2. Description of the Related Art

Referring to FIGS. 1 and 2, a conventional still camera 1 is shown to comprise a camera body 10 having a front side, and a rear side formed with a film-loading chamber that is adapted to receive a roll of film 2 therein. A back-cover member 16 is mounted pivotally on the rear side of the camera body 10 to close the film-loading chamber. The front side of the camera body 10 is formed with a lens-mounting aperture 18 for mounting a lens member 14 thereon. A shutter mechanism 180 is disposed in the camera body 10 between the lens-mounting aperture 18 and the film-loading chamber. By operating a shutter button 12 on the camera body 10, the shutter mechanism 180 can be activated such that the lens member 14 forms an image of a target object on a frame of the film 2 inside the film-loading chamber, thereby exposing the frame of the film 2.

In a conventional digital camera, a captured image is stored in electronic form to permit transmission and processing of the same.

### SUMMARY OF THE INVENTION

One object of the present invention is to provide a dual-use camera, which can be used with a roll of film for capturing images on the film, or with a digital image-capturing device for capturing images in electronic form.

Another object of the present invention is to provide a digital image-capturing device adapted to be mounted removably in a camera body to permit capturing of images in electronic form.

According to one aspect of the invention, a dual-use camera comprises a camera body, a lens member, a shutter mechanism, and a digital image-capturing device. The camera body has a front side, and a rear side formed with a film-loading chamber that is adapted to receive a roll of film therein. The lens member is mounted on the front side of the camera body. The shutter mechanism is disposed in the camera body between the lens member and the film-loading chamber. When the roll of film is disposed in the film-loading chamber, the shutter mechanism is capable of being activated such that the lens member forms an image of a target object on a frame of the film inside the film-loading chamber to expose the frame of the film.

The image-capturing device is mounted removably in the film-loading chamber, and includes an image-sensing device having a sensing plane, and a lens unit disposed in front of the image-sensing device. The image-sensing device and the lens unit are aligned with the lens member along an optical axis when the image-capturing device is disposed in the film-loading chamber. When the image-sensing device is disposed in the film-loading chamber, the shutter mechanism is capable of being activated such that the lens unit refracts light rays from the lens member so as to adjust focusing and size of an image of a target object that is formed on the sensing plane of the image-sensing device according to dimensions of the sensing plane. The image-sensing device generates digital image data corresponding to the image formed on the sensing plane thereof. The image-capturing device further includes a memory device coupled electrically to the image-sensing device for storing the digital image data therein, and a control device coupled electrically to the image-sensing device and the memory device. The control device is capable of being activated so as to control exposure time of the image-sensing device, and further controls storage of the digital image data in the memory device.

According to another aspect of the invention, a digital image-capturing device is adapted for use with a camera body having a front side and a rear side formed with a film-loading chamber that is adapted to receive a roll of film therein. The front side of the camera body has a lens member mounted thereon. The camera body is provided with a shutter mechanism therein between the lens member and the film-loading chamber. When the roll of film is disposed in the film-loading chamber, the shutter mechanism is capable of being activated such that the lens member forms an image of a target object on a frame of the film inside the film-loading chamber to expose the frame of the film.

The image-capturing device is adapted to be mounted removably in the film-loading chamber, and comprises an image-sensing device having a sensing plane, a lens unit disposed in front of the image-sensing device, a memory device, and a control device. The image-sensing device and the lens unit are adapted to be aligned with the lens member along an optical axis when the image-capturing device is disposed in the film-loading chamber. When the image-sensing device is disposed in the film-loading chamber, activation of the shutter mechanism enables the lens unit to refract light rays from the lens member so as to adjust focusing and size of an image of a target object that is formed on the sensing plane of the image-sensing device according to dimensions of the sensing plane. The image-sensing device generates digital image data corresponding to the image formed on the sensing plane thereof. The memory device is coupled electrically to the image-sensing device for storing the digital image data therein. The control device is coupled electrically to the image-sensing device and the memory device. The control device is capable of being activated so as to control exposure time of the image-sensing device, and further controls storage of the digital image data in the memory device.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional still camera;

FIG. 2 is an exploded perspective view of the conventional still camera of FIG. 1;

FIG. 3 is a fragmentary rear perspective view of the preferred embodiment of a dual-use camera according to the present invention;

FIG. 4 is a fragmentary partly cutaway schematic top view of the preferred embodiment;

FIG. 5 is a partly cutaway schematic side view of the preferred embodiment;

FIG. 6 is a schematic circuit block diagram of a digital image-capturing device of the preferred embodiment;

FIG. 7 illustrates how the preferred embodiment operates when used to capture images on a roll of film;

FIG. 8 illustrates how the preferred embodiment operates when used to capture images in electronic form; and

FIG. 9 is a schematic circuit block diagram of a modified digital image-capturing device for a dual-use camera according to this invention.

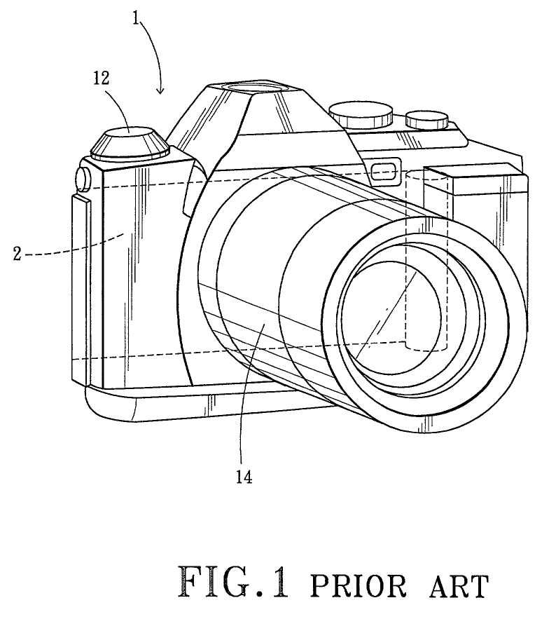

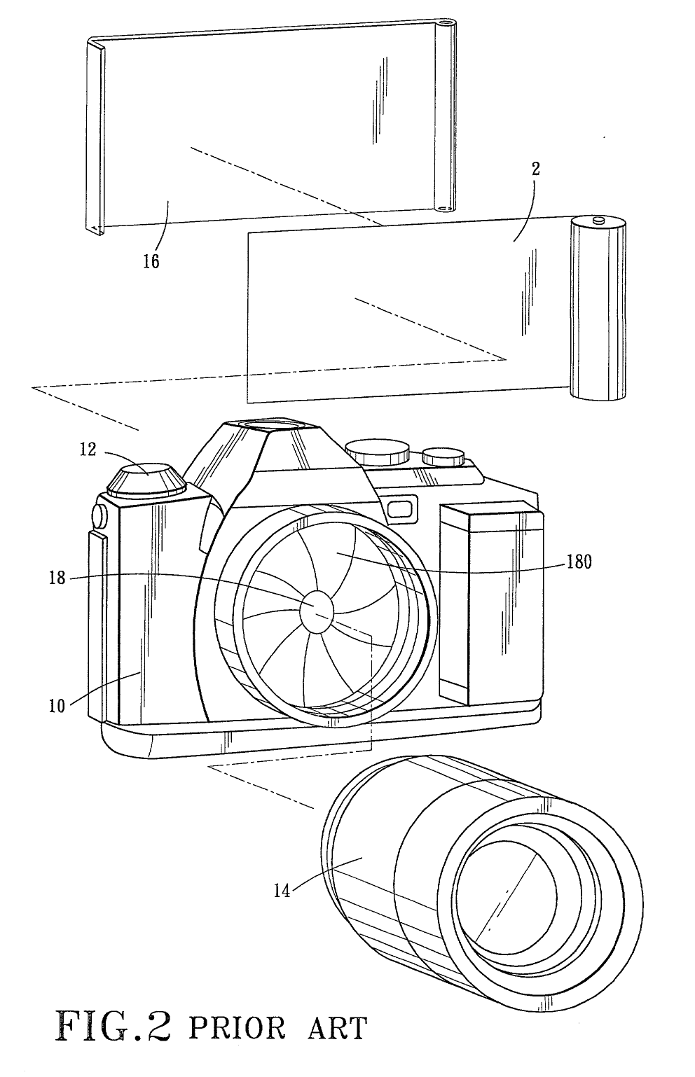

### DETAILED DESCRIPTION OF THE PREFERRED EMBODIMENTS

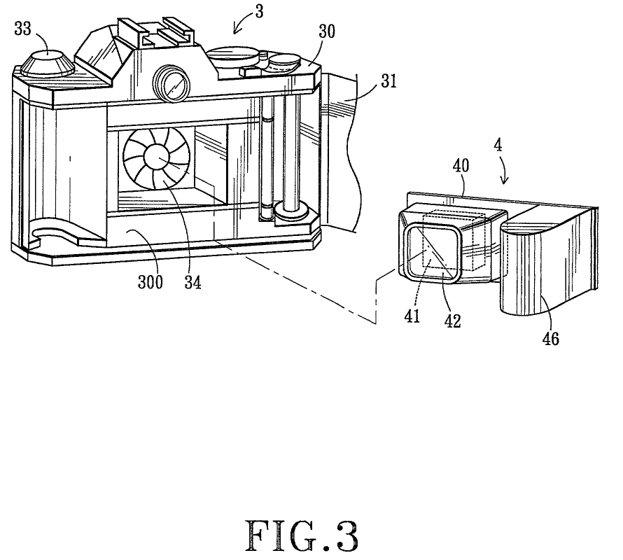

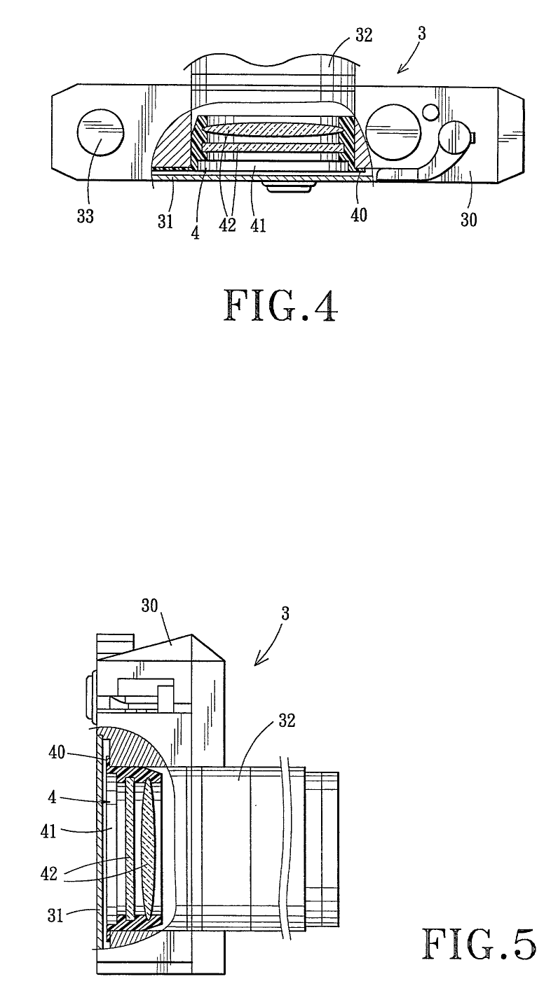

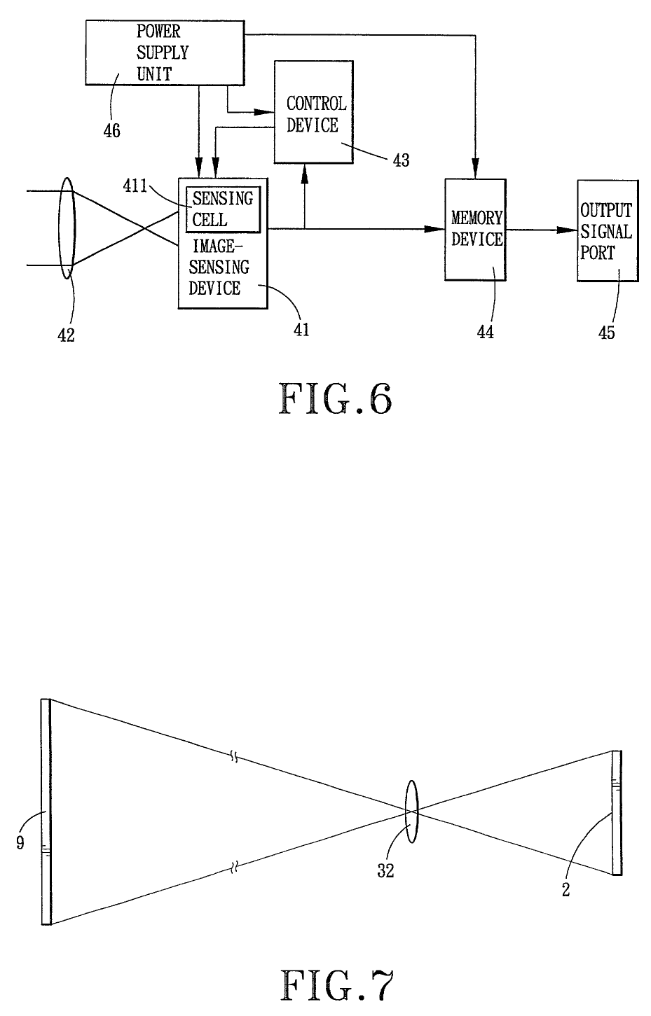

Referring to FIGS. 3, 4, 5 and 6, the preferred embodiment of a dual-use camera 3 according to the present invention is shown to comprise a camera body 30 similar to that of the conventional still camera 1 described beforehand. The camera body 30 has a front side, and a rear side formed with a film-loading chamber 300 that is adapted to receive a roll of film 2 (see FIG. 7) therein. A back-cover member 31 is mounted pivotally on the rear side of the camera body 30 so as to close the film-loading chamber 300. A lens member 32, such as a 35-mm lens member, is mounted on the front side of the camera body 30 in a known manner. A conventional shutter mechanism 34 is disposed in the camera body 30 between the lens member 32 and the film-loading chamber 300. With further reference to FIG. 7, when the film-loading chamber 300 is loaded with a roll of film 2, operation of a shutter button 33 on the camera body 30 will activate the shutter mechanism 34 such that the lens member 32 forms an image of a target object 9 on a frame of the film 2 inside the film-loading chamber 300, thereby exposing the same. Unlike the conventional still camera 1 described beforehand, the dual-use camera 3 further comprises a digital image-capturing device 4 for capturing images in electronic form. The image-capturing device 4 includes an image-sensing device 41, a lens unit 42, a memory device 44, a control device 43, an output signal port 45, and a power supply unit 46 that are mounted on a base board 40. The base board 40 is fitted removably in the film-loading chamber 300. Retaining means (not shown) may be provided to immobilize releasably the base board 40 in the film-loading chamber 300. The image-sensing device 41, which is a CMOS array digital image sensor in this embodiment, has a sensing plane. The lens unit 42, such as a plano-convex lens unit, is disposed in front of the image-sensing device 41. When the base board 40 is disposed in the film-loading chamber 300, the lens unit 42 and the image-sensing device 41 are preferably aligned with the lens member 32 along an optical axis.

In a conventional still camera, each frame of a roll of film is approximately 36 mm×24 mm in size. If the image-sensing device of the image-capturing device 4 is constructed to have a sensing plane with the same area, the production yield will be undesirably low, and the production cost will be unreasonably high.

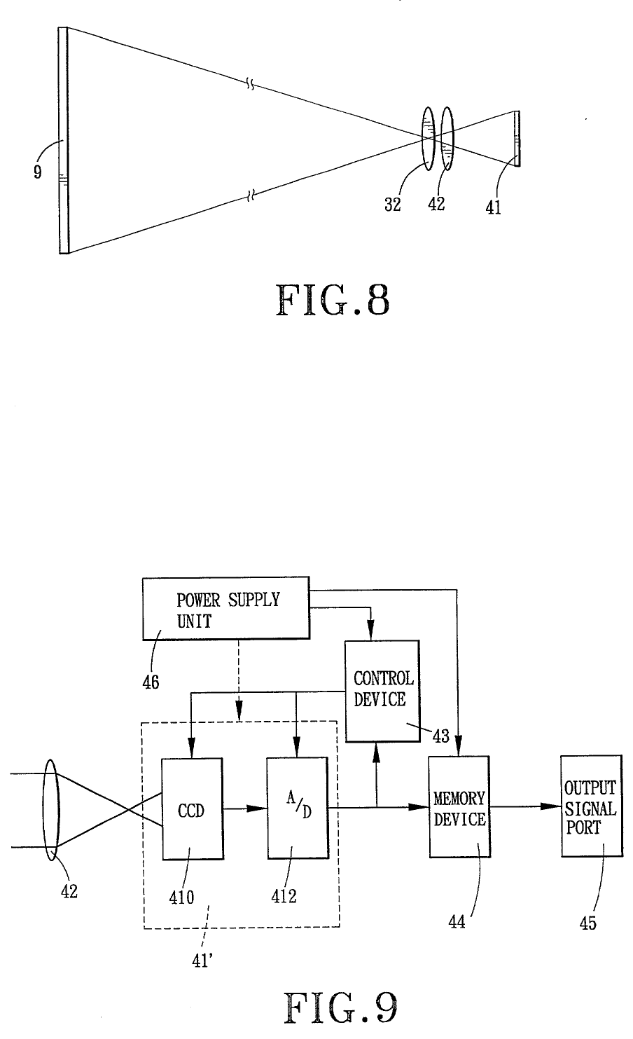

In the preferred embodiment, the sensing plane of the image-sensing device 41 is approximately 5.6 mm×4.2 mm in size. Thus, without altering the lens member 32, the shutter mechanism 34 and other components in the camera body 30, in order for a properly focused and appropriately sized image of the target object 9 to be formed on the sensing plane of the image-sensing device 41 when the image-capturing device 4 is disposed in the film-loading chamber 300, there is a need to provide the lens unit 42, which refracts the light rays from the lens member 32 according to the dimensions of the sensing plane to achieve the desired effect, as best shown in FIG. 8. The image-sensing device 41 then generates digital image data corresponding to the image formed on the sensing plane thereof.

The memory device 44 is coupled electrically to the image-sensing device 41 and is used to store the digital image data therein. The control device 43 is coupled electrically to the image-sensing device 41 and the memory device 44, the purpose of which will be described hereunder.

When it is desired to capture images in electronic form, the image-capturing device 4 is mounted in the film-loading chamber 300. Thereafter, the shutter button 33 is operated to activate the shutter mechanism 34. An image of the target object is formed on the sensing plane of the image-sensing device 41 via the lens member 32 and the lens unit 42 at this time. At the same time, the control device 43 detects the actuation of the shutter mechanism 34 and controls the exposure time of the image-sensing device 41. In the preferred embodiment, the image-sensing device 41 includes a sensing cell 411 that is monitored by the control device 43 so as to detect the actuation of the shutter mechanism 34. By monitoring the output of the sensing cell 411, the control device 43 is able to determine whether an appropriate threshold has been reached, thereby indicating sufficient exposure time for the image-sensing device 41. Of course, an independent light sensor may be employed to serve the purpose of the sensing cell 411 described beforehand. Upon detection that an appropriate threshold has been reached, indicative of the occurrence of a predetermined exposure, the control device 43 subsequently terminates further exposure of the image-sensing device 41 to prevent over-exposure. The control device 43 then controls the memory device 44 to store the digital image data from the image-sensing device 41 therein.

The output signal port 45 is coupled electrically to the memory device 44 such that the digital image data stored in the memory device 44 can be accessed by an external processing or storage device upon removal of the image-capturing device 4 from the film-loading chamber 300.

The power supply unit 46, such as a battery unit, is coupled electrically to the image-sensing device 41, the control device 43, and the memory device 44 so as to supply electric power thereto. The power supply unit 46 is adapted to extend into a film canister-receiving portion of the film-loading chamber 300 when the image-capturing device 4 is disposed in the chamber 300.

FIG. 9 illustrates a modified digital image-capturing device of this invention. Unlike the previous embodiment, the image-sensing device 41′ includes an array analog image sensor 410, such as a charge-coupled device (CCD), and an analog-to-digital (A/D) converter 412 coupled electrically to the charge-coupled device 410 for converting the analog output of the analog image sensor 410 into the digital image data to be stored in the memory device 44.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A dual-use camera, comprising:
a camera body having a front side and a rear side formed with a film-loading chamber that is adapted to receive a roll of film therein;
a lens member mounted on said front side of said camera body;
a shutter mechanism disposed in said camera body between said lens member and said film-loading chamber, wherein when the roll of film is disposed in said film-loading chamber, said shutter mechanism is capable of being activated such that said lens member forms an image of a target object on a frame of the film inside said film-loading chamber to expose the frame of the film; and
a digital image-capturing device mounted removably in said film-loading chamber, and including an image-sensing device having a sensing plane, and a lens unit disposed in front of said image-sensing device;
wherein said image-sensing device and said lens unit are aligned with said lens member along an optical axis when said image-capturing device is disposed in said film-loading chamber;
wherein when said image-sensing device is disposed in said film-loading chamber, said shutter mechanism is capable of being activated such that said lens unit refracts light rays from said lens member so as to adjust focusing and size of an image of a target object that is formed on said sensing plane of said image-sensing device according to dimensions of said sensing plane, said image-sensing device generating digital image data corresponding to the image formed on said sensing plane thereof;
said image-capturing device further including a memory device coupled electrically to said image-sensing device for storing the digital image data therein, and a control device coupled electrically to said image-sensing device and said memory device, said control device being capable of being activated so as to control exposure time of said image-sensing device and further controlling storage of the digital image data in said memory device.

2. The dual-use camera of claim 1, wherein said image-sensing device includes an array digital image sensor.

3. The dual-use camera of claim 1, wherein said image-sensing device includes an array analog image sensor and an analog-to-digital converter coupled electrically to said array analog image sensor.

4. The dual-use camera of claim 1, wherein said image-sensing device includes sensing cell means for activating said control device upon detecting activation of said shutter mechanism, said control device monitoring status of said sensing cell means and terminating exposure of said image-sensing device upon detection that a predetermined exposure has occurred.

5. The dual-use camera of claim 1, wherein said image-capturing device further includes an output signal port coupled electrically to said memory device.

6. A digital image-capturing device adapted for use with a camera body having a front side and a rear side formed with a film-loading chamber that is adapted to receive a roll of film therein, said front side of said camera body having a lens member mounted thereon, said camera body being provided with a shutter mechanism therein between said lens member and said film-loading chamber, wherein when the roll of film is disposed in said film-loading chamber, said shutter mechanism is capable of being activated such that said lens member forms an image of a target object on a frame of the film inside said film-loading chamber to expose the frame of the film, said image-capturing device being adapted to be mounted removably in said film-loading chamber, and comprising:
an image-sensing device having a sensing plane;
a lens unit disposed in front of said image-sensing device;
wherein said image-sensing device and said lens unit are adapted to be aligned with said lens member along an optical axis when said image-capturing device is disposed in said film-loading chamber;
wherein when said image-sensing device is disposed in said film-loading chamber, activation of the shutter mechanism enables said lens unit to refract light rays from said lens member so as to adjust focusing and size of an image of a target object that is formed on said sensing plane of said image-sensing device according to dimensions of said sensing plane, said image-sensing device generating digital image data corresponding to the image formed on said sensing plane thereof;
a memory device coupled electrically to said image-sensing device for storing the digital image data therein; and
a control device coupled electrically to said image-sensing device and said memory device, said control device being capable of being activated so as to control exposure time of said image-sensing device and further controlling storage of the digital image data in said memory device.

7. The digital image-capturing device of claim 6, wherein said image-sensing device includes an array digital image sensor.

8. The digital image-capturing device of claim 6, wherein said image-sensing device includes an array analog image sensor and an analog-to-digital converter coupled electrically to said array analog image sensor.

9. The digital image-capturing device of claim 6, wherein said image-sensing device includes sensing cell means for activating said control device upon detecting activation of said shutter mechanism, said control device monitoring status of said sensing cell means and terminating exposure of said image-sensing device upon detection that a predetermined exposure has occurred.

10. The digital image-sensing device of claim 6, further comprising an output signal port coupled electrically to said memory device.
